(19) United States
(12) Patent Application Publication
(10) Pub. No.: US 2025/0224575 A1
(43) Pub. Date: Jul. 10, 2025

(54) FLIP-CHIP INTEGRATED PHOTONIC DEVICES FOR OPTICAL ENGINES

(71) Applicant: ELEPHINT INC., San Jose, CA (US)

(72) Inventors: Peter Lit Deh CHANG, San Jose, CA (US); Ricky TSENG, San Jose, CA (US)

(21) Appl. No.: 19/011,352

(22) Filed: Jan. 6, 2025

Related U.S. Application Data
(60) Provisional application No. 63/618,390, filed on Jan. 8, 2024.
(60) Provisional application No. 63/714,285, filed on Oct. 31, 2024.

(51) Int. Cl. G02B 6/42

(52) U.S. Cl. CPC G02B 6/4214

(57) ABSTRACT

A flip-chip bonded photonic device and methods of fabrication are described. The device has a spot size converter and an antireflective coating on a sidewall of the spot size converter. The device has a semiconductor layer comprising a stack of quantum wells and an etch stop semiconductor layer beneath the layer comprising a stack of quantum wells. The device has a vertical sidewall for optical coupling and a sloped sidewall for metal interconnects. The device has a substrate and an optical waveguide residing above substrate. A mirror is coupled to the optical waveguide that bends light from the optical waveguide and transmits the light through the substrate. The light expands as it passes through the substrate. A collimating lens receives the light transmitted through the substrate and is lithographically aligned with the mirror. An optical engine has a flip-chip integrated electro-absorption modulated laser (EML) on a substrate.

### CROSS REFERENCE TO RELATED APPLICATIONS

The present application claims the benefit of priority from U.S. Provisional Patent Application No. 63/618,390, filed Jan. 8, 2024, entitled HYBRID OPTICAL ENGINES FOR COMPUTING NETWORKS, and U.S. Provisional Patent Application No. 63/714,285, filed Oct. 31, 2024, entitled FLIP-CHIP INTEGRATION OF PHOTONIC DEVICES, both of which are hereby incorporated by reference in the entirety.

### FIELD

The field of the embodiments relates to photonic integrated circuits. More particularly, the embodiments relate to high performance photonic integrated circuits using flip-chip integration.

### BACKGROUND

Data center and supercomputers require high performance interconnects in volume. The bandwidth (BW) needs to increase by two times every two years. High BW can be addressed by high data rate per lane, high number of lanes, or both. For computing networks, high speed optical interconnects provide high bandwidth communications among computing units.

A device that converts electrical signals into optical signals and vice versa is referred to as an optical engine (OE). A photonic integrated circuit (PIC) for an OE comprises high speed metal interconnects, optical waveguides (WGs), optical modulators, wavelength division multiplexers (WDM), photodetectors, and WGs-to-fiber-optic coupling structures. A PIC can be either silicon-based or compound semiconductor-based.

Traditional methods utilizing wire bonding of compound semiconductor photonic devices have limited performance at high data rates. Silicon photonics have not been able to match up to the performance of compound semiconductor photonic devices. Nevertheless, compound semiconductors, such as materials made of group III and group V (IIIV), suffer from higher substrate defects and smaller substrate sizes compared to silicon. Photonic integrated circuits that are IIIV-based have been used in telecom in low volume at high cost but are unable to address the datacom market need for high volume at low cost.

Silicon Photonics (SiPh) has been developed for the past two decades for the datacom market. Laser light sources, however, cannot be made out of silicon. Many methods have been proposed to integrate IIIV lasers on a Si platform. These methods, however, tend to have poor yield, and the performance of silicon modulators cannot match that of IIIV modulators. The industry has yet to produce high performance SiPh PICs in volume at low cost for datacom.

### SUMMARY

A flip-chip bonded photonic device is described that has a spot size converter and an antireflective coating on a sidewall of the spot size converter.

A flip-chip bonded photonic device is described that has a semiconductor layer comprising a stack of quantum wells and an etch stop semiconductor layer beneath the layer comprising a stack of quantum wells.

A flip-chip bonded semiconductor device is described that has a vertical sidewall for optical coupling and a sloped sidewall for metal interconnects.

A flip-chip bonded photonic device is described that has a substrate and an optical waveguide residing above substrate. A mirror is coupled to the optical waveguide that bends light from the optical waveguide and transmits the light through the substrate. The light expands as it passes through the substrate. A collimating lens is fabricated on the back side of the substrate for receiving the light transmitted through the substrate and is lithographically aligned with the mirror.

An optical bridge is described that has a substrate and an optical waveguide residing above the substrate. A first mirror is coupled to a first end of the optical waveguide that bends light from the optical waveguide and transmits the light through the substrate. The light expands as it passes through the substrate. A second mirror is coupled to a second end of the optical waveguide that bends light from the optical waveguide and transmits the light through the substrate. The light expands as it passes through the substrate. A first collimating lens is fabricated on the back side of the substrate for receiving the light transmitted through the substrate and is lithographically aligned with the first mirror. A second collimating lens is fabricated on the back side of the substrate for receiving the light transmitted through the substrate and is lithographically aligned with the second mirror.

A method of fabricating a flip-chip bonded photonic device is described. A first dielectric layer acting as an etch stop layer is deposited on a silicon-on-insulator (SOI) substrate. A waveguide is patterned above the dielectric etch stop layer. After the waveguide is patterned, a spot size converter is deposited and patterned so that a first end portion of the spot size converter resides over a portion of the waveguide. Cladding is deposited over the waveguide and the spot size converter. A second dielectric layer is deposited that covers a side of the spot size converter opposite the waveguide. A third dielectric layer is deposited over the second dielectric layer that covers the side of the spot size converter opposite the waveguide.

A method of forming a flip-chip bonded photonic device is described. An etch stop semiconductor layer is formed in a substrate. A semiconductor layer comprising a stack of quantum wells is formed above the etch stop semiconductor layer.

A method of forming a flip-chip bonded semiconductor device is described. A vertical sidewall for optical coupling is formed by etching with a first mask. A sloped sidewall for metal interconnects is formed by etching with a second mask.

A method of forming a flip-chip bonded photonic device is described. A silicon dioxide layer is deposited on a silicon on insulator (SOI) layer on a substrate. A silicon epitaxial layer is grown over the silicon dioxide layer in a window in a dielectric layer over the silicon dioxide layer. A 45-degree mirror is formed in the silicon epitaxial layer. The substrate is flipped. Photoresist lithographically aligned to the mirror is patterned and the photoresist is reflowed to form a spherical shape as an etch mask. A lens is formed by etching.

An optical engine is described that has a flip-chip integrated electro-absorption modulated laser (EML) on a substrate. The EML includes a continuous wave distributed feedback laser and an electro-absorption modulator (EAM). The optical engine also includes a laser monitor on the substrate and a photodetector on the substrate.

An optical engine is described that has a flip-chip electro-absorption modulator (EAM) on a substrate. The optical engine includes a laser that is separate from the EAM. The optical engine also includes a photodetector on the substrate.

Other features and advantages of the disclosed embodiments will be apparent from the accompanying drawings and from the detailed description.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram of co-packaged optical engines on packages of network switch, GPU, CPU, FPGA, or memory.

FIGS. 2A-2C are diagrams of a CPO engine as an interposer with vertical coupling to a two-dimensional (2D) fiber optic array.

FIGS. 2D-2E are cross section views of a flip-chip bonded photonic device on a substrate.

FIGS. 3A-3C are block diagrams of OEs with flip-chip photonic devices in various configurations.

FIG. 4 is a cross-section view of epitaxial structure for photonic devices on a compound semiconductor substrate.

FIGS. 5-8 are cross-section views of processing steps following FIG. 4 up to patterning of metal interconnects and solder for flip-chip bonding.

FIGS. 9A-9C are cross-section views of FIG. 8 with mechanical stops in various embodiments for flip-chip integration.

FIGS. 10A-10C are cross-section views of flip-chip bonded photonic chip with various embodiments of mechanical stops in FIGS. 9A-9C.

FIGS. 11-14 are top views of masking for etching bonding cavity with optimal sidewalls for optical coupling and metal interconnects.

FIG. 15 is a cross-section view of vertical sidewalls for optical coupling and sloped sidewalls for metal interconnects.

FIG. 16 is a cross-section view of a bonding cavity after formation of metal lines.

FIG. 17 is a cross-section view of a bonding cavity with a completed mechanical stop.

FIG. 18 is a top view of a flip-chip bonded electro-absorption modulator (EAM) on a substrate.

FIGS. 19 and 20 are top view and side view of a photonic chip with electro-absorption modulated lasers (EML) flip-chip bonded on a substrate.

FIG. 21 illustrates mechanism of coupling to a 2D fiber optic array.

FIGS. 22-27 illustrate fabrication of a silicon mirror next to a waveguide (WG) for 2D coupling.

FIG. 28 illustrates fabrication of bonding cavity on silicon bench with 2D coupling.

FIG. 29 illustrates photoresist patterning for lenses on the backside of a silicon bench on a carrier.

FIG. 30 illustrates lens patterning and through-silicon via (TSV) on a carrier.

FIG. 31 illustrates a completed silicon bench for 2D fiber optic array coupling.

### DETAILED DESCRIPTION

As described in more detail below, embodiments relate to integrating high performance compound semiconductor photonic devices on silicon through flip-chip integration to realize high bandwidth photonic integrated circuits (PICs) at low power and low cost suitable for datacom, lidar, health sensing, and quantum computing.

The disclosure shows structures for light transmission between silicon-based and non-silicon-based devices with butt coupling. Mechanical stops in a vertical direction with minimal process variations and without overly constraining the assembly process are illustrated.

High speed metal interconnects to IIIV modulators are optimized with slanted sidewalls while optical couplings are optimized with vertical sidewalls on silicon substrates. Methods for fabricating both structures for integrating arrays of IIIV photonic devices are illustrated.

Besides high-speed lanes, a two-dimensional (2D) array of coupling structures is proposed to increase the number of optical fibers (also referred to as fibers) coupled to the PIC. The 2D coupling is accomplished by bending light in waveguides (WGs) by 90 degrees towards lenses lithographically patterned on the other side of the substrate. The light beam expands through the substrate and is collimated by the lens for coupling with lensed fibers. The lithographically patterned lenses provide tight alignment to silicon WGs and relax the alignment requirement between fibers and WGs to allow passive assembly of systems at low cost.

Methods in this disclosure utilize tools and materials known in the semiconductor industry. High performance optical engines therefore can be mass produced at low costs.

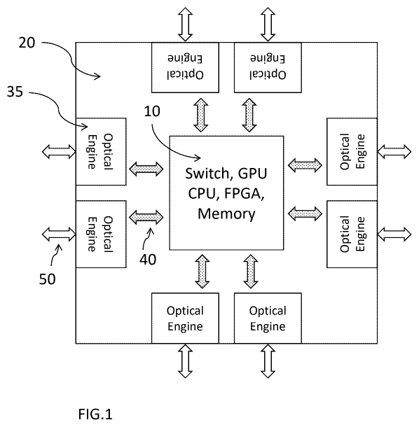

Silicon integrated circuits (ICs) such as network switches, central processing units (CPUs), graphic processing units (GPUs), field programmable arrays (FPGAs), and memories need very high communication bandwidths with other ICs in networks. FIG. 1 illustrates co-packaged optical engines. Integrated circuit 10 in FIG. 1 is typically packaged on substrate 20 that is mounted on a printed circuit board (PCB) that houses other components of a system. IC 10 communicates with other components on a PCB through interconnects 50. As the bandwidth requirement has increased, optical signaling has been replacing electrical signaling given the benefit of using low power at long distances. To enable optical signaling, optical engines (OEs) 35 are placed on package 20 to convert electrical signals 40 to optical ones. An OE integrated on an IC package is referred to as a co-packaged optical (CPO).

The bandwidth of an OE can be improved with a high data rate per optical channel, a high number of optical channels, a high number of optical channels in a fiber, and a high number of fibers attached to the OE. This disclosure sets forth methods for flip-chip integration of compound semiconductor photonic devices for a high data rate and a high number of optical channels. New methods are set forth for coupling with 2D fiber arrays to increase the number of optical fibers.

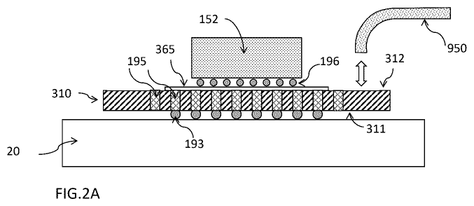

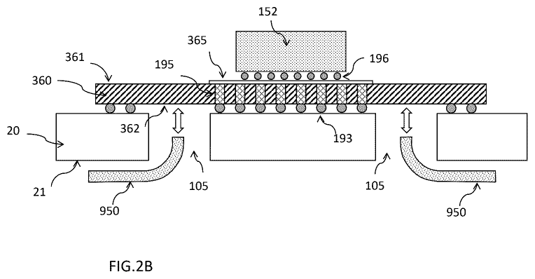

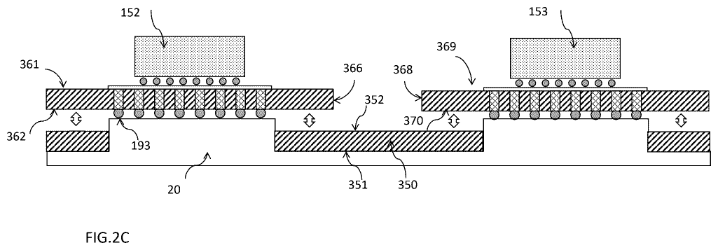

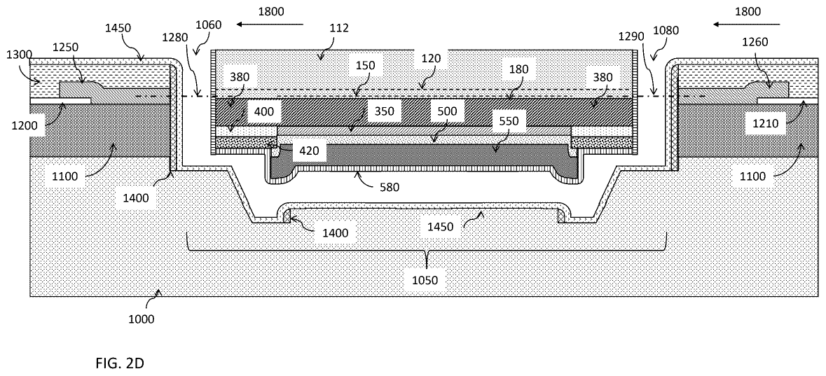

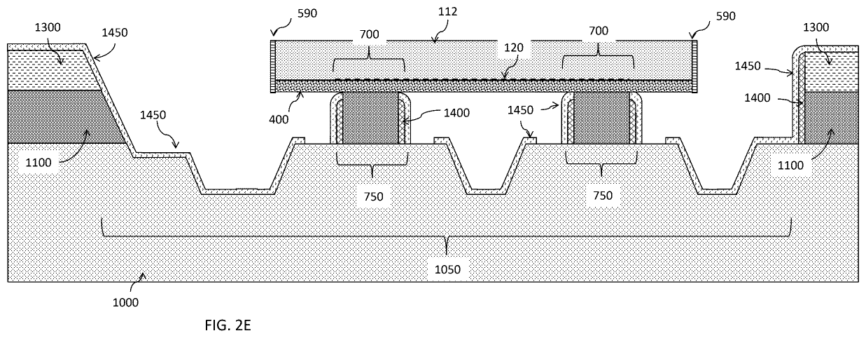

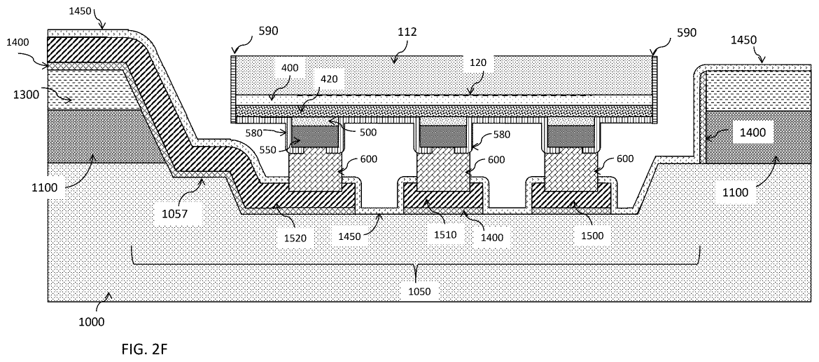

FIG. 2A illustrates an optical engine on a package as an interposer. FIG. 2A shows an OE 310 as an interposer for computing unit 152 with a two-dimensional (2D) fiber coupling. Optical devices and waveguides (WGs) of OE 310 are on surface 311 so that IC 152 communicates with them through (1) solder 196, (2) redistribution layer 365, and (3) through-silicon-vias (TSVs) 195. Optical signals on surface 311 are directed towards surface 312 and coupled with a 2D fiber array 950 to increase the number of fibers attached to the optical engine. Coupling structures and fabrication methods will be described below.

FIG. 2B shows another embodiment of an optical engine as an interposer. FIG. 2B shows an embodiment where OE 360 is an interposer for IC 152 and couples to fibers through holes 105 in substrate 20. Optical devices and waveguides of OE 360 are on surface 361 and coupling structures are on surface 362 on the opposite side. Optical signals on surface 361 are directed towards surface 362 for coupling with fiber array 950. IC 152 communicates with OE 360 without going through TSV 195. Fiber array 950 can run either perpendicular or parallel to package 20. Coupling structures and fabrication methods for this embodiment are the same as those for FIG. 2A.

FIG. 2C shows an optical interconnect between computing units on a large package. FIG. 2C shows an embodiment for chip-to-chip optical interconnects on a large package 20 with multiple computing units. Optical devices and WGs of OEs 366 and 368 are on surfaces 361 and 369 with coupling structures on surfaces 362 and 370, respectively. Optical bridge 350 has WGs on surface 351 with coupling structures on surface 352. Optical signals of OE366 on surface 361 are transmitted to waveguides on surface 351 of optical bridge 350, then to WG on surface 369 of OE 368 through coupling structures. The embodiment provides optical connections between computing units on the same package 20. For one embodiment, devices 366 and 368 are optical computing units instead of optical engines for optical interconnects. Coupling structures and fabrication methods for this embodiment are the same as those for FIG. 2A.

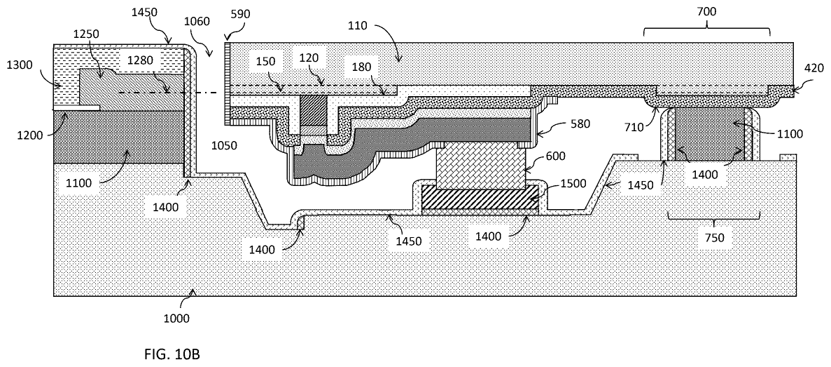

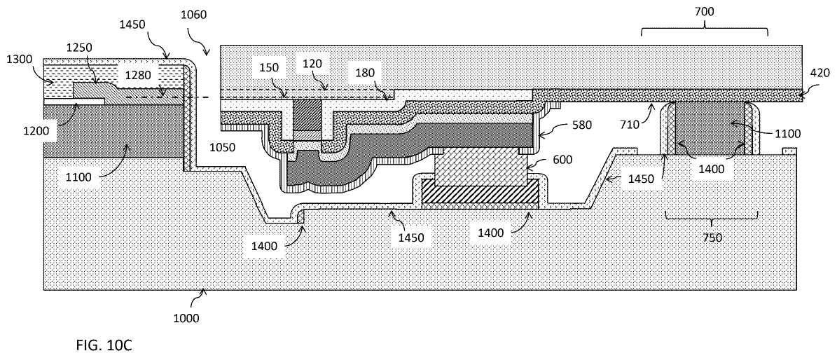

FIG. 2D illustrates flip-chip integration of an electro-absorption modulated laser with matched optical coupling. FIG. 2D is a cross-section view of flip-chip bonded electro-absorption modulator 112 in bond cavity 1050 on silicon substrate 1000. For the embodiment, a light source propagates in waveguide (WG) 1210 on buried oxide 1100 through a spot size converter (SSC) 1260 in direction 1800 across gap 1080 to a ridge waveguide 380 on chip 112. Quantum well (QW) 150 modulates the optical signal at high speed and the modulated light continues in direction 1800 across gap 1060 to SSC 1250 and WG 1200 on buried oxide 1100. To ensure efficient optical coupling across gaps 1080 and 1060, center line 1290 of SSC 1260 and center line 1280 of SSC 1250 need to be matched to QW 150, respectively. Vertical sidewalls of SSCs 1250 and 1260 with antireflection coatings 1400 and 1450 ensure that the light propagates without bending sideways with minimum reflection back into WGs or SSCs. Methods for fabricating bonding cavity 1050 are described in below in connection with FIGS. 10A, 10B, 10C, and 11-17.

In this disclosure, in plane alignments (XY directions) are controlled by an assembly tool and the vertical position (Z) is controlled by mechanical stops, as discussed below in connection with FIG. 2E.

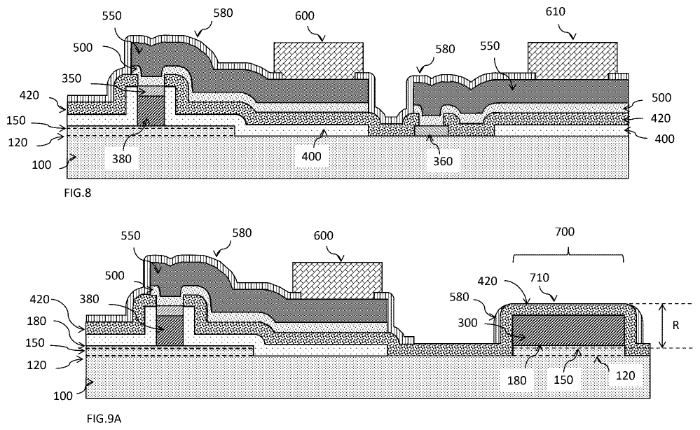

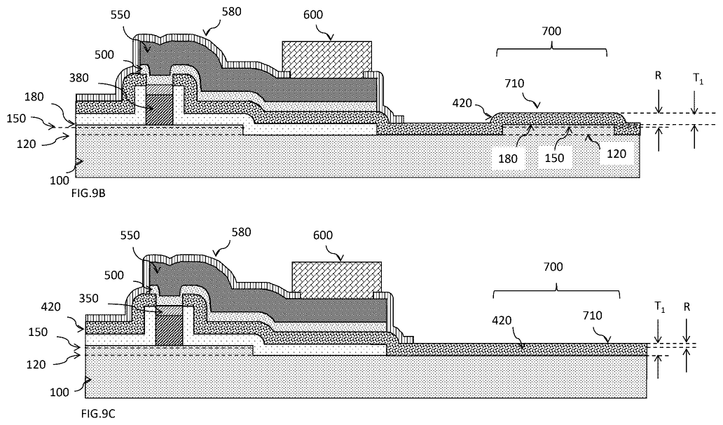

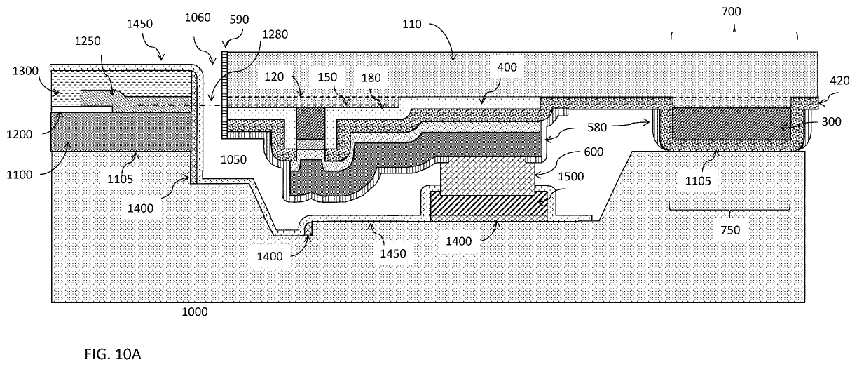

FIG. 2E shows flip-chip integration with mechanical stops in a vertical direction. FIG. 2E is a cross-section view of a region with mechanical stop (MS) 750 on substrate 1000 and mechanical stops 700 on chip 112. Mechanical stop 700 is a dielectric 400 on an etch stop layer 120 and mechanical stop 750 utilizes buried oxide 1100. Location of etch stop 120 and thickness of dielectric 400 are chosen so that center lines 1290 and 1280 are matched to QW150 in FIG. 2D. Variations of the mechanical stops are minimized by virtue of etch stop layer 120 and buried oxide 1100. Methods and various embodiments for mechanical stops are described below in connection with FIGS. 9A, 9B, 9C, 10A, 10B, and 10C.

FIG. 2F illustrates flip-chip integration with solder bonding and sloped sidewalls for metal interconnects. FIG. 2F is a cross-section view of metal interconnects and solder bonding for flip-chip integration in bonding cavity 1050 on substrate 1000. Contour 1057 has sloped sidewalls for running high speed metal interconnects 1500, 1510, and 1520 without wire bonds. Thickness of metal interconnects and thickness of solder 600 are designed to ensure connectivity with mechanical stops in FIG. 2E. Utilizing vertical sidewalls for optical coupling (FIG. 2D) and sloped sidewalls for electrical interconnects is a key feature of this disclosure. Methods for fabricating the features are described below in connection with FIGS. 10A, 10B, 10C, and 11-14.

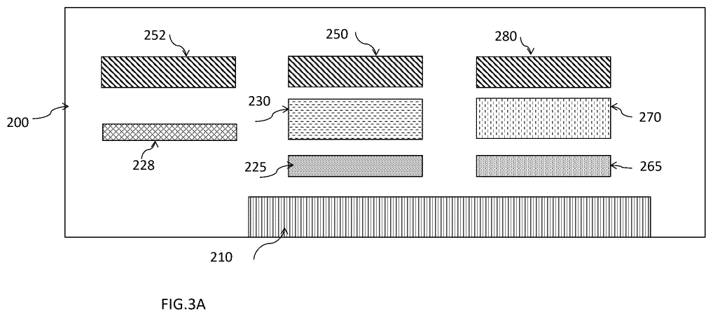

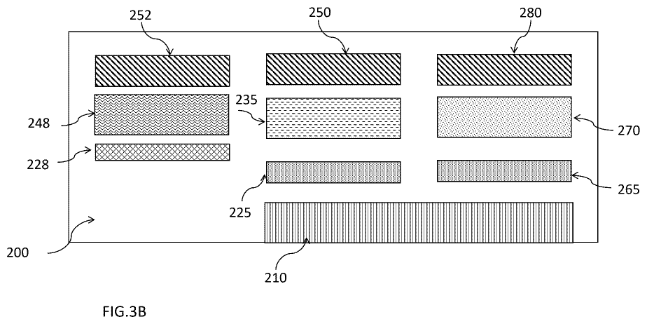

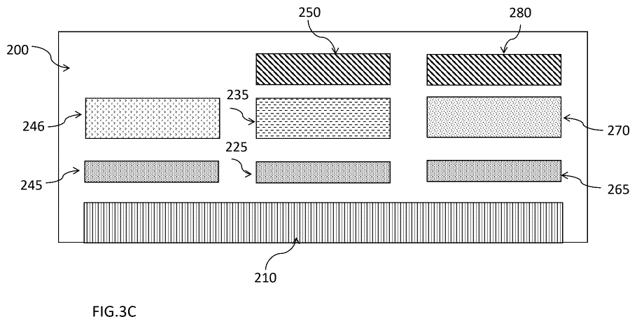

FIG. 3A is a block diagram of an optical engine with an electro-absorption modulated laser (EML) on a chip. FIG. 3A shows a block diagram for one embodiment of OE 200 with an electro-absorption modulated laser. Other embodiments can have more than one EML on a chip. EML 230 comprises of a continuous wave (CW) laser integrated with an electro-absorption modulator. Laser monitor 228 comprises a photodetector coupled to the CW laser of EML for monitoring the laser output. Bond pad 252 provides a power supply for CW lasers on EML 230 and laser monitors 228 at low speed. Bond pad 250 provides signals for electro-absorption modulators on EML 230 at a high data rate. For transmission, modulated light from EML 230 is directed to WDM 225 that combines signals of multiple wavelengths into single fibers connected to OE 200 through coupler 210. For reception, optical signals are coupled from fibers to WDM 265 through coupler 210. Signals of individual wavelengths from WDM 265 are directed to photodetector 270 and electrical signals are sent to external electronic ICs through bond pad 280 at a high data rate. For one embodiment, EML 230 is comprised of flip-chip bonded Indium Phosphide (InP) chips. WDM 225 and WDM265 are silicon-based passive devices. Laser monitor 228 and PD 270 are germanium detectors on a silicon substrate.

FIG. 3B is a block diagram of an optical engine with a chip containing separate lasers and electro-absorption modulators (EAMs). FIG. 3B shows a block diagram for one embodiment of OE 200 with separately integrated lasers and EAMs. For one embodiment, CW lasers 248 and EAMs 235 are flip-chip bonded InP chips. WDM 225 and WDM 265 are silicon-based passive devices. Laser monitor 228 and PD 270 are germanium detectors on a silicon substrate.

FIG. 3C is a block diagram of an optical engine with external lasers and an electro-absorption modulator (EAM). FIG. 3C is a block diagram for one embodiment of OE 200 with external lasers of several different wavelengths. Different wavelengths of external lasers are combined into one fiber and coupled to OE 200 through coupler 210. WDM 245 separates the external lights from each fiber into different wavelengths and power splitter 246 divides light power of each wavelength into several channels feeding EAM 235. For one embodiment, EAM 235 comprises flip-chip integrated InP chips. WDM 225, WDM 245, WDM 265, and power splitter 246 are silicon-based passive devices. PD 270 is comprised of germanium detectors on a silicon substrate.

FIG. 4 shows a compound semiconductor substrate and epitaxial layers. FIG. 4 is a cross-sectional view of epitaxial (also referred to as epi) structures on a compound semiconductor substrate 100. Layer 120 is an etch stop layer, layer 150 is a stack of quantum wells (QW) for electro-optical effects, layer 180 is another etch stop layer, followed by layer 300 for ridge waveguide and contact to QW 150. D₁, D₂ and D₃ denote the thickness between QW 150 and etch stop 120, thickness between QW 150 and etch stop 180, and thickness of layer 300, respectively. D₁ and D₂ range from 10s to 100s of nanometers and D3 ranges from 100s of nanometers to a few microns. For one embodiment, QW 150 is undoped, substrate 100 and epi layers under QW 150 are n-doped and epi layers above QW 150 are p-doped. For one embodiment, QW 150 is for a laser and for another embodiment, it is for an electro-absorption modulator (EAM). For various embodiments disclosed below, epi layer 300, etch stop 180, and etch stop 120 are used as a reference plane for forming mechanical stops with different level of process variations.

FIG. 5 shows p-metal and ridge waveguide patterning. FIG. 5 is a cross-sectional view after patterning of p-contact 350 and ridge waveguide 380. For one embodiment, p-contact metal is first deposited with a metal liftoff, followed by a lithography and an etch process to form the ridge WG380. For one embodiment, a selective wet etch is used to stop at layer 180. Formation of a ridge waveguide with an etch stop is known in the prior art.

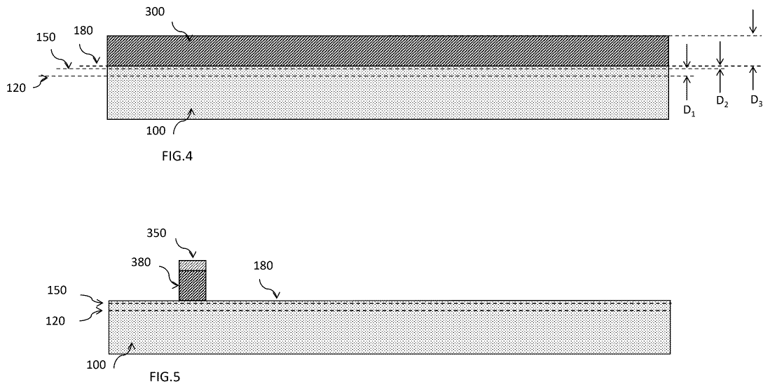

FIG. 6 shows isolation etching and contact patterning. FIG. 6 is a cross-section view following FIG. 5 after an isolation etch, a deposition of dielectric layer 400, patterning to open up p-contact 350 and forming an n-contact 360. For one embodiment, isolation etch removes QW 150 outside active device region 315. For one embodiment, a selective wet etch stops at layer 120 which is N-doped below QW 150. For one embodiment, dielectric layer 400 is deposited and patterned to open windows 410 and 420 for p-contact 350 and n-contact 360 made of n-type metal. For one embodiment, dielectric layer 400 is silicon dioxide. For another embodiment, dielectric 400 is not used and an n-type metal is deposited and patterned to form n-contact 360. Insertion of etch stop layer 120 below QW150 for mechanical stop only in the vertical direction is an embodiment of the invention that provides a tight control on mechanical stops without over-constraining the assembly process. Etch stop layer 120 provides tight control in matching optical modes for efficient optical coupling and more flexibility in the design of ridge WG 380, as illustrated below in connection with the discussion FIG. 9C.

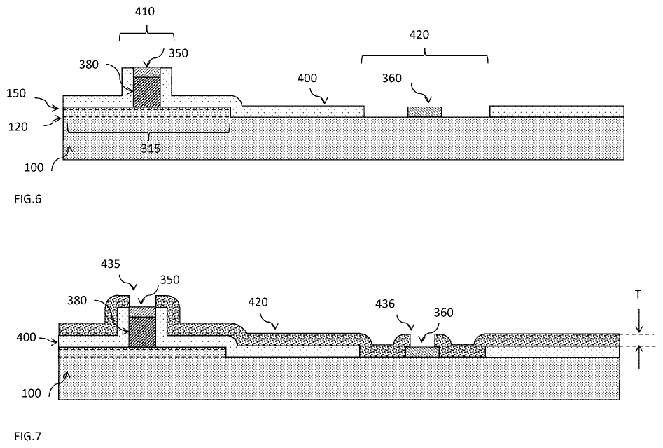

FIG. 7 illustrates dielectric deposition and contact opening. FIG. 7 is a cross-section view following FIG. 6 after deposition of dielectric layer 420 and patterning to open up windows 435 and 436 for contacting p-metal 350 and n-metal 360, respectively. T denotes thickness of dielectric 420 which ranges from 10's of nanometers to a few microns. For one embodiment, dielectric layer 420 is silicon nitride. Dielectric passivation and contact formation are known in the prior art.

FIG. 8 shows n-contact and p-contact bonding pads. FIG. 8 is a cross-section view following FIG. 7 after patterning of interconnects 500 and 550 and solder bumps 600. N-contact 360 and P-contract 350 are in general at different heights on substrate 100. Making their solder bumps at the same height is a key feature to ensure connections to both contacts upon the same bonding process. For one embodiment, metal 500 is a stack of titanium and gold and metal 550 is electrode-plated gold. Metal 550 thickness ranges from a few hundred nanometers to a few microns for low loss electrical signaling at high frequency for high data rate. Thick plated metals are widely used in compound semiconductor devices in the prior art. A dielectric layer 580 is deposited and patterned before solder 600 is deposited. Dielectric layer 580 has a thickness in the range of 10s of nanometers to a few microns. It is applied to stop solder wetting of interconnect 550 outside the solder area. For one embodiment, solder 600 is gold tin. In FIGS. 6-8, locations of contacts and metal interconnects are for illustration only. Various features may not be shown to scale and may not be at the same cross section plane as shown. For example, some part of metal interconnect 550 may run parallel to ridge WG 380 instead of perpendicular to it as illustrated in FIG. 8. Location of solder 610 for N-contact 360 may be close to ridge WG 380 instead of being farther away from solder 600 for P-contact 350.

FIG. 9A illustrates one embodiment of a mechanical stop. FIG. 9A is a cross-section view of one embodiment of FIG. 8 in which mechanical stop 700 contains epitaxial layer 300. The mechanical stop comprises dielectric layer 420, ridge WG layer 300, etch stop 180, QW 150, and etch stop 120 on substrate 100. Surface 710 on top of dielectric 420 serves as a mechanical stop for flip-chip bonding. For one embodiment, dielectric 580 on top of dielectric 420 in region 700 is removed during contact opening etch for solder 600. In one embodiment, dielectric 420 is silicon nitride and dielectric layer 580 is silicon dioxide which can be selectively removed. Surface 710 is above QW 150 by a distance R=T+D₃+D₂ (FIGS. 4 and 7). In one embodiment, dielectric 580 is not etched away in mechanical stop 700, for which case, thickness of dielectric 580 is added to distance R. Relative distance R ranges from 100s of nanometers to a few microns. For one embodiment, D₃=1.1 micron, D₂=150 nanometers, and T=500 nanometers, for which a variation of 175 nm is resulted from 10% cross-wafer variations from epi growth and dielectric 420 deposition. Variations for this embodiment are expected to be a few hundred nanometers, much larger than for the embodiments discussed below in connection with FIGS. 9B and 9C.

FIG. 9B illustrates another embodiment of a mechanical stop. FIG. 9B is a cross-section view of one embodiment of FIG. 8 in which mechanical stop 700 is recessed to etch stop layer 180. The mechanical stop region has dielectric layer 420 on etch stop layer 180. Surface 710 of dielectric 420 serves as a mechanical stop for flip-chip bonding. Processing for this embodiment is the same as that for the embodiment of FIG. 9A, with a different mask layout to remove epitaxial layer 300 in mechanical stop 700. For one embodiment, dielectric 420 on mechanical stop is etched to a target thickness T₁, which can range from 0 to the full thickness T of dielectric 420. QW150 is located at a distance R=D₂+T₁ from surface 710. Relative distance R is in the range of hundreds of nanometers. For one embodiment, D₂ is 150 nm (nanometers) and T₁ is 250 nm, for which a variation of 40 nm results from 10% cross-wafer variations from epitaxial growth and dielectric 420 deposition. Variations for this approach are expected to be 10s of nanometers, much less than that for the embodiment of FIG. 9A.

FIG. 9C shows yet another embodiment of a mechanical stop. FIG. 9C is a cross-section of one embodiment of FIG. 8 in which mechanical stop 700 is recessed to etch stop layer 120. The mechanical stop region has dielectric layer 420 on etch stop layer 120. Surface 710 on top of dielectric 420 serves as a mechanical stop for flip-chip bonding. Processing for this embodiment is the same as that for the embodiment of FIG. 9A, with a different mask layout to remove epitaxial layer 300, etch stop 180, and QW 150 in mechanical stop 700. Surface 710 is above etch-stop layer 120 by the thickness T₁ of layer 420, where T₁ may be less than the full thickness of layer 420 if an etch is applied to the mechanical stop region. QW 150 is located at a distance R=D₁−T₁ from surface 710. QW 150 can be above or below surface 710 for matching to center line 1280, depending on the magnitude of D₁ and T₁. For one embodiment, R is −200 nm with D₁=150 nm and T₁=350 nm, for which case, a variation of 50 nm is resulted from 10% cross-wafer variations from epi growth and dielectric 420 deposition. Variations for this approach are expected to be tens of nanometers, similar to that of the embodiment of FIG. 9B and much less than that of the embodiment of FIG. 9A. The embodiment provides more flexibility in the design of ridge WG 380 by decoupling D₂ and D₃ from the design of mechanical stop 700.

FIGS. 10A-10C are cross-sectional views of a flip-chip bonded photonic chip 110 in cavity 1050 on substrate 1000 for the embodiments of FIGS. 9A-9C, respectively. Features common to these embodiments are described below, with features specific to each embodiment discussed in the respective discussions of FIGS. 10A, 10B, and 10C.

For one embodiment, WG 1200 extends to the edge of gap 1060 for optical coupling. In one embodiment, a spot size converter (SSC) 1250 is used to expand mode size of WG 1200, which has a thickness in the range of a few hundred nanometer for single mode optical profile. For one embodiment, SSC 1250 is silicon nitride with a thickness in the range of a few hundred nanometers to one micron. In the prior art, silicon nitride WGs are formed on silicon WGs after planarization of a dielectric cladding on WG 1200. The remaining dielectric over WG 1200 after planarization is difficult to control and impacts optical coupling between WG 1200 and SSC 1250. This disclosure proposes a new method for fabricating SSC 1250 without planarization to improve the coupling.

For one embodiment, a dielectric etch-stop layer is deposited on silicon on insulator prior to patterning of WG 1200. In one embodiment, the dielectric etch-stop layer is aluminum oxide, which cannot be etched by fluorine based dry etch for silicon-based materials. After formation of WG 1200, dielectric layer for SSC 1250 is deposited over WG 1200 and patterned. For one embodiment, dielectric layer for SSC 1250 is silicon nitride. Dielectric etch stop layer protects WG 1200 from dry etch that forms SSC 1250. For another embodiment, dielectric etch-stop layer is deposited post WG 1200 patterning to protect it from patterning of SSC 1250. Cladding 1300 is deposited following patterning of WG 1200 and SSC 1250. For one embodiment, cladding 1300 is silicon dioxide.

Layers 1400 and 1450 are deposited on the sidewall of SSC 1250 as an antireflection coating. Dielectric 1400 and 1450 ranges from 10s to 100s of nanometers. For one embodiment, dielectric 1400 and 1450 are silicon dioxide. Dielectric 1400 insulates metal 1500 from substrate 1000. For one embodiment, high resistivity substrate 1000 is used so that metal 1500 is deposited on substrate 1000 without dielectric layer 1400. Dielectric 1450 prevents solder wetting of metal 1500 outside the solder area. Details of methods for forming cavity 1050 are further described below in connection with FIGS. 11-17.

For one embodiment, materials can be deposited to fill gap 1060 post flip-chip bonding. The gap fill protects the optical path and allows liquid cooling. For one embodiment, the filling material is a UV curable polymer.

FIG. 10A illustrates an embodiment of flip-chip photonic devices on a substrate, corresponding to the embodiment of FIG. 9A. For the embodiment of FIG. 10A, buried oxide 1100 on substrate 1000 in mechanical stop 750 is removed in order to accommodate layer 300 in mechanical stop 700 on chip 110 while matching Z locations of SSC 1250 and QW 150. For one embodiment, the two are matched with D₃=1.5 micron, D₂=150 nm, T=550 nm and a 400 nm thick SSC 1250 on a 2 um thick buried oxide 1100.

FIG. 10B illustrates an embodiment of flip-chip photonic devices on a substrate, corresponding to the embodiment of FIG. 9B. For the embodiment of FIG. 10B, buried oxide 1100 in region 750 is kept in order to match SSC 1250 and QW 150 with reasonable thicknesses of various layers. For this embodiment, thickness of buried oxide 1100 does not impact the matching of SSC 1250 and QW 150. For one embodiment, D₂ is 150 nm and T₁ is 100 nm with a 500 nm thick SSC 1250 on top of buried oxide 1100; QW 150 and SSC 1250 are matched at 250 nm above buried oxide 1100.

FIG. 10C illustrates an embodiment of flip-chip photonic devices on a substrate, corresponding to the embodiment of FIG. 9C. The embodiment of FIG. 10C is similar to the embodiment of FIG. 10B, with more flexibility in tuning the Z height of mechanical stops 700 and 750 with etch stop layer 120 on chip 110. For one embodiment, D₁ is 150 nm, and T is 400 nm, and SSC 1250 is 500 nm; QW 150 and SSC 1250 are matched at 250 nm above buried oxide 1100.

For various embodiments as illustrated in FIGS. 10A-10C, cavity 1050 needs to be deep enough to accommodate the topography of chip 110. The depth of cavity 1050 can range from a few microns to 10 microns. The topography is large enough so that the sidewalls of cavity 1050 need to be engineered for connections from the top of substrate 1000 to the bottom of cavity 1050 (FIG. 2F). FIGS. 11-17 illustrate the design and process for bonding cavity 1050 with slanted sidewall for high-speed metal interconnects and vertical sidewalls for optical coupling.

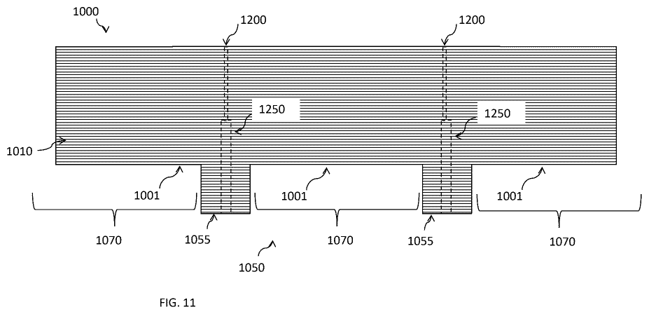

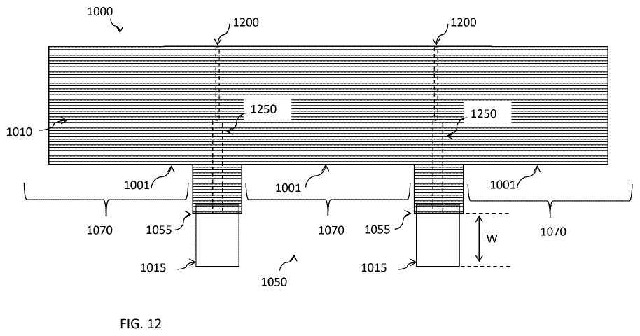

FIG. 11 illustrates masking for an initial cavity etch. FIG. 11 is a top view of substrate 1000 with hard mask (HM) 1010 for the first etching of bonding cavity 1050. At this point, WG 1200 and SSC 1250 are cladded with dielectric 1300 (FIGS. 10A-10C) and protected by HM 1010. Subsequent etching defines edge 1001 in recess 1070 for metal interconnects and edge 1055 for optical coupling. For one embodiment, the first etch stops at silicon substrate after the removal of cladding dielectric and buried oxide (1300 and 1100 in FIGS. 10A-10C). FIG. 12 illustrates masking for vertical sidewall processing for coupling area. For the embodiment of FIG. 12, additional photoresist is patterned with mask 1015 to open up windows adjacent to the optical coupling region 1055 for etching into silicon substrate. The windows extend beyond coupling edge 1055 by a distance W, which can range from 100s of nanometers to 100s of microns. HM 1010 protects coupling edges 1055 during the etching in the windows of mask 1015. For one embodiment, substrate materials in windows of mask 1015 below buried oxide are removed with enough depth for accommodating coupling WG on photonic chip (WG 380 in FIG. 2D). The etch depth can range from a few hundred nanometers to a few microns. For one embodiment, the sidewall of coupling edge 1055 is vertical suitable for optical coupling.

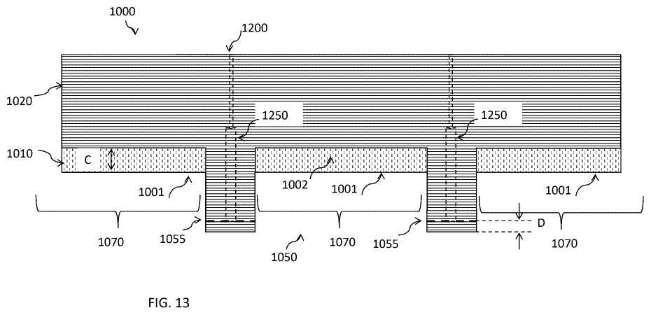

FIG. 13 illustrates masking for sloped sidewalls processing for metal interconnects. FIG. 13 is a top view of another etch with mask 1020 following the etches discussed in connection with FIGS. 11 and 12. Mask 1020 is offset from mask 1010 by a distance C to expose region 1002 in recess 1070 for etching. Distance C can range from a few hundred nanometers to 100s of microns. Mask 1020 extends beyond coupling edge 1055 by a distance D to protect coupling edge 1055. Distance D can range from a few hundred nanometers to 100s of microns. For one embodiment, etching with mask 1020 creates sloped sidewalls in recesses 1070 outside optical coupling region for metal interconnects. Sloped sidewalls for regions adjacent to coupling edge 1055 is at distance D away at a lower level without impacting optical coupling.

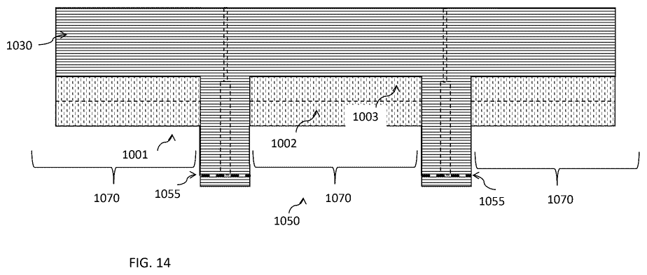

FIG. 14 illustrates masking for staircase sidewalls processing for metal interconnects. FIG. 14 is a top view of one embodiment with mask 1030 following the etch with mask 1020 discussed in connection with FIG. 13. Mask 1030 is offset from mask 1020 in a similar way as mask 1020 is from mask 1010. Region 1003 is exposed for etching to create a staircase profile in recesses 1070. The scheme can be repeated until a target depth of cavity 1050 is reached. A staircase profile with sloped sidewalls in recesses 1070 can enable metal interconnects in a deep cavity 1050.

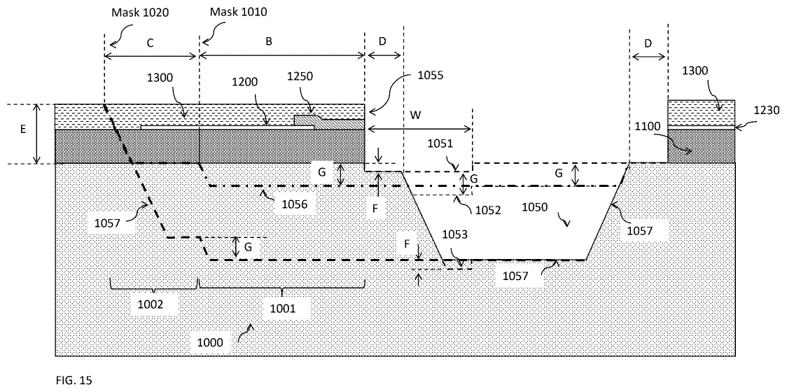

FIG. 15 illustrates sloped sidewalls for metal interconnects and vertical sidewalls for optical coupling. FIG. 15 is a cross-section view of one embodiment of FIGS. 11-13 forming sloped sidewalls for metal interconnects in cavity 1050. Labels are defined in the same way as previously described in FIGS. 11-14. For one embodiment, the first etch with HM 1010 in FIG. 11 removes cladding 1300, buried oxide 1100 and stops at the silicon substrate. A following etch with mask 1015 in FIG. 12 resulted in a vertical sidewall profile as shown by dashed line 1051. For one embodiment, recess F is large enough for accommodating coupling waveguides on photonic chip (FIG. 2D). F can range from 0 to 5 microns. Following the etching of optical coupling region, for one embodiment, etching with mask 1020 in FIG. 13 creates sloped sidewalls. For one embodiment, contours 1056 and 1052 show the profiles of substrate in region 1070 and optical coupling window W at the end of etching cladding 1300 and buried oxide 1100 with selective etching (G<E). During the etch, coupling edge 1055 is protected by photoresist extended beyond the coupling edge by a distance D (FIG. 13). For one embodiment, final contour 1057 forms sloped sidewalls adjacent to masking edges with a step height G at the bottom as transferred down from contour 1056. Contour 1051 is similarly etched down to contours 1052 and 1053 with sloped sidewalls adjacent to masking edge at distance D from edge 1055. A step height F relative to the bottom part of contour 1057 is transferred down from contour 1051 without adverse effect on subsequent processing. For this embodiment, sloped sidewalls are created for metal interconnects in recess 1070 while coupling edge 1055 has a vertical sidewall for optical coupling.

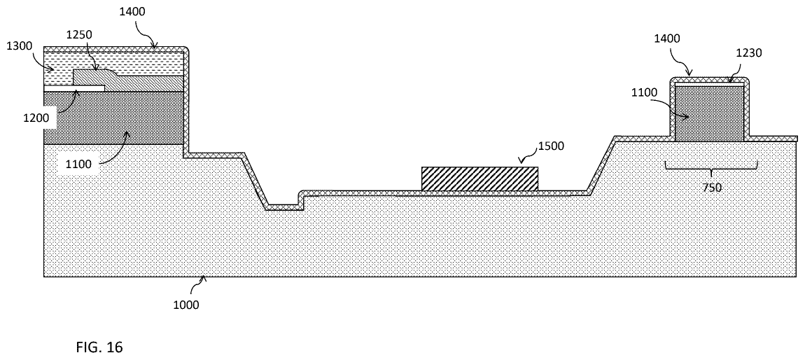

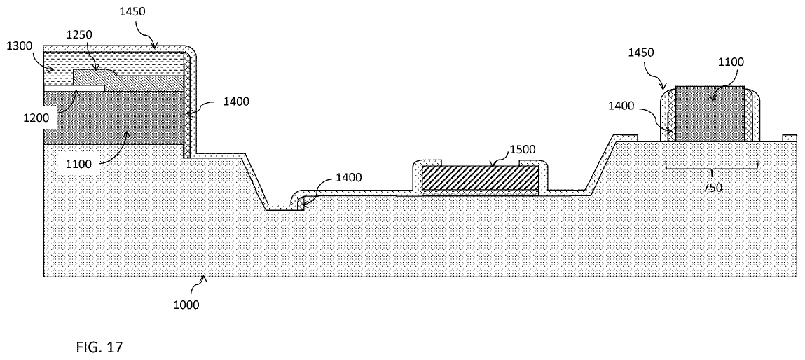

FIGS. 16 and 17 illustrate methods for fabricating remaining structures on substrate 1000 for flip-chip integration. FIGS. 16 and 17 each illustrate flip-chip bonded photonic devices on a substrate corresponding to FIG. 7C. FIG. 16 is a cross-section view after metal interconnect 1500 is formed following cavity 1050 etching in FIG. 15. For one embodiment, cladding 1300 on mechanical stop 750 is removed on top of SOI 1230. Dielectric 1400 is deposited on substrate 1000 as part of AR coating for SSC 1250 and insulates metal interconnect from the substrate. Metal interconnect 1500 is patterned following deposition of dielectric 1400.

FIG. 17 is a cross-section view following the process operation illustrated in FIG. 16. For one embodiment, a spacer etch removes dielectric 1400 on top of mechanical stop 750 to the level of buried oxide 1100. For one embodiment, photoresist is patterned to protect dielectric 1400 on the sidewalls of SSC 1250 or WG 1200. Second dielectric 1450 is deposited and removed on metal 1500 and on top of mechanical stop 750 to the level of buried oxide 1100. Layer 1230 shown in FIG. 16 is finally removed with a selective etch of silicon and stopped at buried oxide 1100. For one embodiment, dielectrics 1400 and 1450 are combined to function as an anti-reflection coating for WG 1200 or SSC 1250. Dielectric 1400, 1450, and buried oxide 1100 can be further selectively etched down to silicon substrate 1000 for the embodiment described in connection with FIG. 10A.

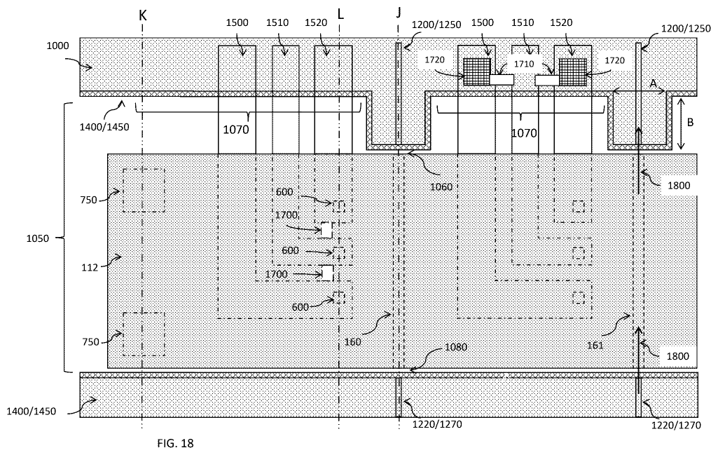

FIG. 18 illustrates flip-chip integrated electro-absorption modulators on a substrate. FIG. 18 is a top view of photonic chip 112 flip-chip bonded on silicon substrate 1000 with solder bumps 600. In FIG. 18, backside of chip 112 faces up (FIGS. 10A-10C). Features on substrate 1000 under chip 112 are shown by dotted dashed lines. Features on chip 112 facing down are shown by dashed lines. For the embodiment shown in FIG. 18, chip 112 contains EAM devices with ridge WG160/WG161, which are coupled to WG 1200 or SSC 1250 at one end across gap 1060 and to WG 1220 or SSC 1270 across gap 1080 at the other end. Light travels in direction 1800 and is modulated by electrical signals transmitted via metal lines 1500, 1510, and 1520, which form co-planar strip lines for ground, signal, and ground, respectively. Cavity 1050 has recess 1070 for metal interconnects 1500, 1510, and 1520 away from the optical coupling gap 1060. For optimal optical coupling, sidewalls of coupling gaps 1060 and 1080 are vertical while metal connections are achieved with sloped sidewalls at recess 1070.

FIGS. 2D, 2E, and 2F are cross section views along cut lines J, K, and L, respectively. Section J is through WG 160 and WG 1200/SSC 1250 for the optical path. Section K is through mechanical stop 750. Section L is through metal interconnects 1500, 1510, 1520, and solder bumps 600.

In FIG. 18, widths of metal lines 1500, 1510 and 1520 and gaps between them range from a few microns to 10's of microns. Recess 1070 allows coupling gap 1060 to be less than 1 micron while allowing metal interconnects to be thicker than 1 micron for electrical signaling at high frequency. The depth B of recess 1070 can range from a few microns to 100's of microns. Width A for optical coupling can range from a few microns to 10's of microns.

In FIG. 18, resistor 1700 is a termination for co-planar strip lines. For one embodiment, resistor 1700 is made of tantalum nitride. The thickness of resistor 1700 can range from 10's nanometers to 100's of nanometers with widths and lengths in the range of a few microns to 10's of microns. For one embodiment, a 50-ohm termination resistor can be designed and fit in one gap between coplanar strip lines 1500 and 1510. For another embodiment, two resistors 1700 can fit in two gaps between the signal line 1510 and two ground lines 1500 and 1520. For one embodiment, resistor 1700 is placed at the bottom of cavity 1050. For another embodiment, resistor 1710 and a decoupling capacitor 1720 may be placed on cladding 1300 (FIGS. 10A-10C) outside cavity 1050 prior to the etching of the cavity. The decoupling capacitor 1720 is used to cut off power consumption due to DC bias on EAMs 160/161 while grounding high frequency signals with terminator resistor 1710. At 50 Gigahertz (GHz), decoupling capacitors can be in the range of 10s of microns with electrodes sandwiching a high-K dielectric such as aluminum oxide or hafnium oxide. For one embodiment, decoupling capacitor 1720 is placed on lines 1500 and 1520 at the bottom of bonding cavity 1050. For another embodiment, resistor 1700 and decoupling capacitor 1720 are placed on photonic chip 112 between bond pads.

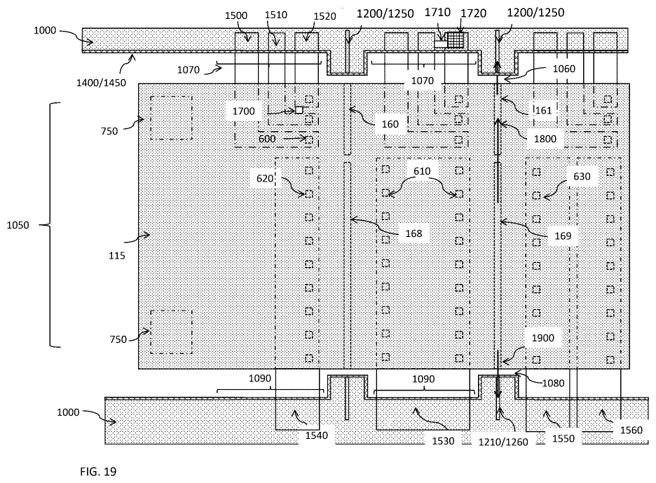

FIG. 19 illustrates electro-absorption modulated lasers (EMLs) flip-chip bonded on a substrate. FIG. 19 is a top view of one embodiment in which photonic chip 115 contains EMLs. An electro-modulated laser (EML) comprises a continuous wave (CW) distributed feedback laser (DFB168/DFB169) and an electro-absorption modulator (EAM160/EAM161). DFB168/169 generates light that travels in the direction of arrow 1800 into EAM 160/161, respectively. The modulated optical signals travel into WG 1200/SSC 1250 on substrate 1000 across gap 1060. For one embodiment, a small portion of light from DFB168/169 is sent in the direction of arrow 1900 into WG 1210 or SSC 1260 across gap 1080. Light enters WG 1210 or SSC 1260 and is guided to a photodetector on substrate 1000 for monitoring the performance of DFB168/169. For one embodiment, the laser monitor is a Ge photodiode monolithically fabricated on silicon.

In FIG. 19, metal interconnects 1530, 1540, 1550, and 1560 contact an array of DFBs 168, 169, etc. on chip 115. They run from the bottom of cavity 1050 to the top of substrate 1000 across recess region 1090. Recess 1090 is processed in the same way as recess 1070, with sloped sidewalls beneficial for metal interconnects without affecting optical coupling across gap 1080. Unlike metal interconnects for an electro-absorption modulator (EAM), interconnects for DFB operates essentially at DC and need to conduct heat generated from DFB to substrate 1000. It is desirable to make interconnects 1530, 1540, and 1550 as large as possible for thermal conduction. For one embodiment, (1) interconnect 1530 is a shared N-contact for DFBs 168 and 169 through solders 610, (2) interconnect 1540 connects to P-contact of DFB 168 through solders 620, and (3) interconnect 1550 connects to P-contact of the DFB 169 through solder 630. Solders 610, 620, and 630 for DFBs can be as large as possible to enhance thermal conduction from DFB to metal interconnects. The solder bumps can be from a few to 100s of microns. For one embodiment, metal interconnects 1530, 1540, 1550, and 1560, etc., can each range from 10 microns to 10 millimeters in length.

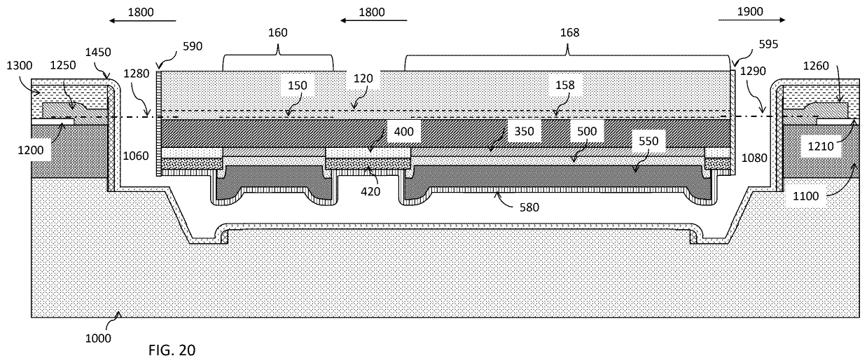

FIG. 20 illustrates flip-chip integration of electro-absorption modulated lasers (EMLs). FIG. 20 is a cross-section view of the embodiment of FIG. 19 along the waveguides of the EML. Features of EAM are implemented on EML in the same way. QW150 is for EAM 160 and QW158 is for laser 168. The centers of SSC1250 and SSC1260 (lines 1280 and 1290) are matched to QW150 of EAM 160 and QW158 of DFB 168, respectively. Cross-section views for mechanical stop 750 and metal interconnects are similar to those shown in FIGS. 2E and 2F.

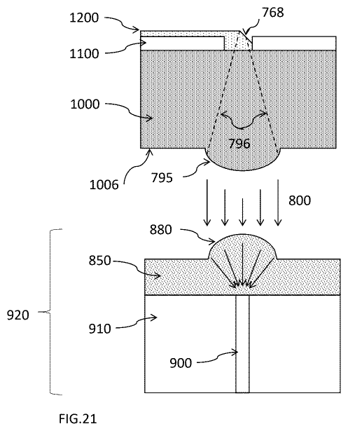

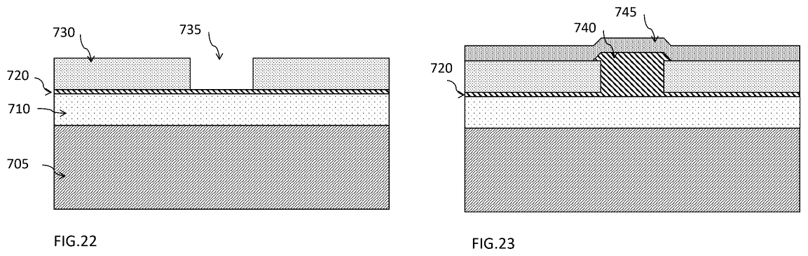

Methods for two-dimensional (2D) fiber coupling are disclosed below to increase the number of fibers in and out of an OE. FIG. 21 illustrates light bending and lenses for a 2D fiber coupler. FIG. 21 illustrates the operational principle for coupling with a 2D array of fibers through lenses. WG 1200 is patterned on buried oxide 1100 and connected to a 45-degree mirror 768. Light propagated in WG 1200 is reflected by mirror 768 towards substrate 1000 and the beam is expanded before being collimated by lens 795 into parallel beams 800, which are focused by lens 880 into fiber 900 mounted together on fixture 910. Assembly 920 is a lensed fiber array known in the prior art. For one embodiment, lens 795 is fabricated lithographically on the back side surface 1006 of substrate 1000 with tight alignment to mirror 768. For one embodiment, the alignment error is less than 100 nm, suitable for single mode optical signaling. The diameters of lenses 795 and 880 are in the range of 10's to 100's microns. Due to large spot sizes compared to sub-micron WGs, alignment between lenses 795 and 880 are relaxed significantly, with an alignment tolerance larger than 10 microns. An embodiment of the invention creates beam expansion through substrate 1000 and lithographic alignment between lens 795 and mirror 768 to enable relaxed alignment between WG1200 and fiber 900. Methods for fabricating lens array 795 are described below in connection with FIGS. 22-31.

FIG. 22 illustrates a silicon (Si) bench mirror etch. FIG. 22 is a cross section of initial processing of optical engines for two-dimensional (2D) coupling. The start wafer has an SOI layer 720 on buried oxide 710 on silicon substrate 705. For one embodiment, SOI is 9.7-degree offcut from (001). A dielectric layer 730 is blanket deposited on SOI 720. For one embodiment, dielectric layer 730 is silicon dioxide. A window 735 is etched in dielectric 730 for mirror epitaxial growth.

FIG. 23 illustrates mirror epitaxial growth and planarization oxide deposition. FIG. 23 is a cross section following FIG. 22. A silicon epitaxial layer 740 is over grown in window 735 of FIG. 22. Epi 740 will have the same crystal orientation as SOI 720. Layer 745 is deposited for planarization. For one embodiment, layer 745 is silicon oxide.

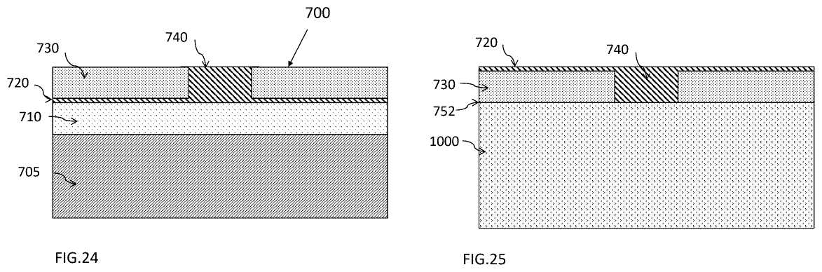

FIGS. 24 and 25 show cross sections following FIG. 23. FIG. 24 illustrates mirror epitaxial planarization. Layer 745 of FIG. 23 is polished and planarized to expose the top surface of epi 740, as shown in FIG. 24. FIG. 25 illustrates a flipped after bond and substrate removal. Wafer 700 is flipped and bonded to a silicon carrier 1000 with oxide-oxide bonding at the interface 752 between dielectric layer 730 and silicon substrate 1000. As shown in FIG. 25, following the bonding, substrate 705 and buried oxide 710 are removed.

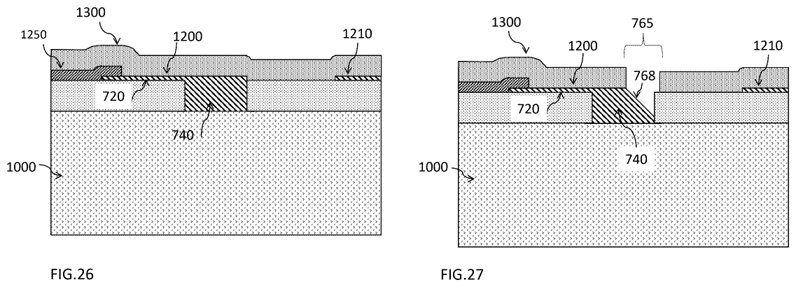

FIG. 26 illustrates silicon (Si) waveguide patterning and cladding. FIG. 26 is a cross section following FIG. 25. SOI layer 720 is patterned to form WG 1200, SSC 1250, and other devices 1210. Device 1210 may be echelle gratings for WDM or incorporating germanium photodetectors. Dielectric layer 1300 is deposited as WG cladding. For one embodiment, dielectric 1300 is silicon dioxide.

FIG. 27 illustrates mirror window opening and a crystal wet etch. FIG. 27 is a cross section following FIG. 26. A window 765 is opened in layer 1300 with photoresist and etching. For one embodiment, 45-degree mirror 768 is formed with a crystal wet etch in epi 740 grown on a 9.74-degree offcut SOI 720. Errors in crystal cut may result in angle of mirror 768 in the range of 44 to 46 degrees. For another embodiment, mirror 768 is formed with ion milling or dry etch of a non-offcut SOI 720. Mirror 768 bends light in WG 1200 towards substrate 1000 with total internal reflection. For one embodiment, metal is deposited on mirror 768 to reflect the light.

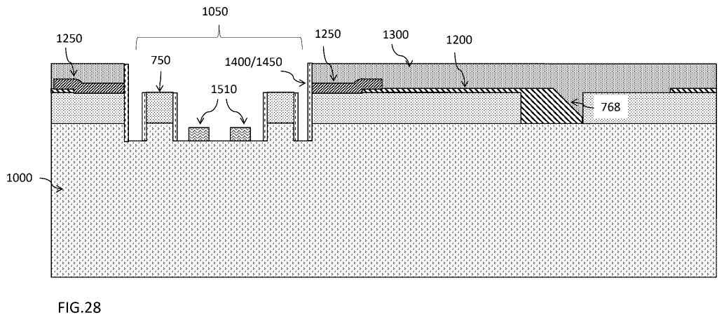

FIG. 28 illustrates bonding cavity patterning. FIG. 28 is a cross section following FIG. 27 for processing bonding cavity 1050. For one embodiment, a sacrificial dielectric layer is deposited and planarized to protect mirror 768 through subsequent processing. For one embodiment, metal interconnects for redistribution layer 365 in FIGS. 2A-2C can be formed post planarization of cladding 1300 and prior to processing of bonding cavity 1050, as illustrated in FIGS. 11-17. Features in cavity 1050 are shown for simplicity.

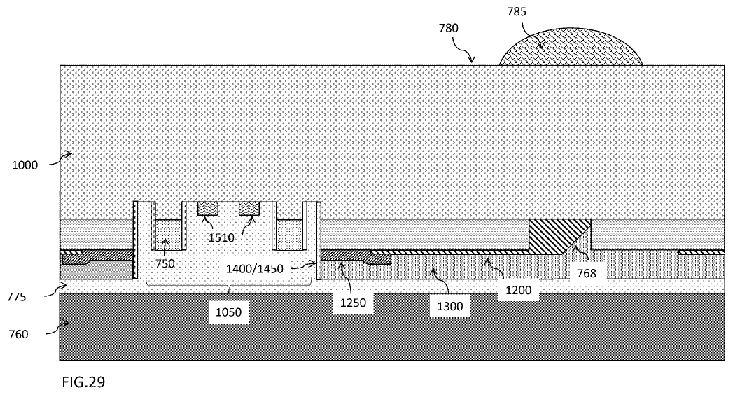

FIG. 29 illustrates lithography for a two-dimensional (2D) lens array. FIG. 29 is the cross section for lens fabrication following FIG. 28. Substrate 1000 is flipped and bonded to a temporary carrier 760 with adhesive 775. Substrate 1000 is thinned down to a thickness suitable for beam expansion from mirror 768. For some embodiments, substrate 1000 is thinned down to less than 500 microns. Photoresist 785 is patterned on surface 780 lithographically aligned to mirror 768 and reflowed to form a spherical shape as an etch mask.

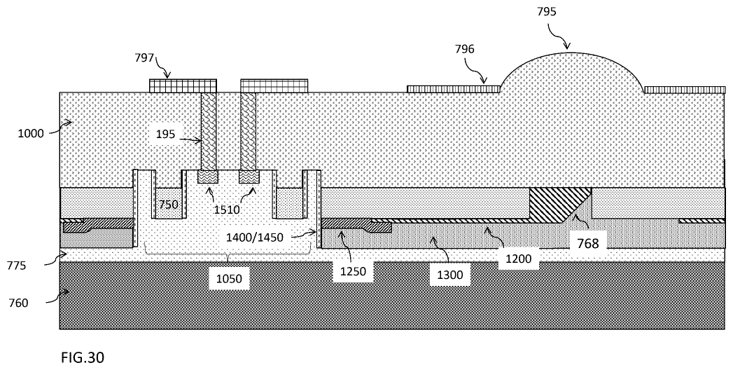

FIG. 30 illustrates lens and through-silicon via (TSV) patterning. FIG. 30 is the cross section after etching to form lens 795. For one embodiment, silicon and photoresist have the same etch rate so that the shape of photoresist 785 is transferred into silicon. To eliminate stray light outside the lens area, absorber 796 can be deposited around lens 795. For one embodiment, absorber 796 is germanium selectively grown on silicon substrate 1000 at low temperatures with a dielectric mask. For one embodiment, through-silicon vias (TSVs) are formed to land on metal pads 1510 for contacting flip-chip bonded photonic devices. Metal pad 797 is then formed on top of TSV 195 for placing solders 193 of FIGS. 2A-2C.

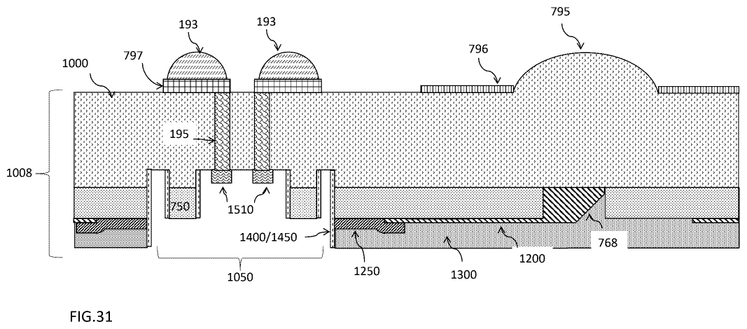

FIG. 31 illustrates a completed silicon interposer with lenses for 2D coupling. FIG. 31 is the cross-section view of a completed silicon bench following FIG. 30. For one embodiment, adhesive 775 is thermally de-bonded at high temperatures and cleaned. For another embodiment, carrier 760 in FIG. 30 is glass, and adhesive 775 is removed with laser exposures. Solder balls 193 and 196 shown in FIGS. 2A-2C can be placed on either side of silicon bench 1008. The wafer is ready for flip-chip integration of non-silicon based optical devices.

Embodiments are herein described for flip-chip integration of arrays of photonic devices and for two-dimensional (2D) fiber optic coupling. The flip-chip integration enables high speed electrical and optical signaling in a small physical size, which in turn enables a large number of optical channels in an optical engine. The 2D coupling scheme significantly increases the number of optical fibers with relaxed alignment tolerance. These methods utilize existing tools and materials to enable mass production at low cost for datacom, lidar, and other sensor applications.

Mechanical stops can limit variations in vertical positions to tens of nanometers while matching optical modes in photonic devices and waveguides on the substrate for optimal optical transmissions. Methods for fabricating photonic devices and substrates to ensure low loss optical coupling and high-speed electrical connections are disclosed.

In the foregoing specification, specific embodiments have been referenced. It will, however, be evident that various modifications and changes may be made thereto without departing from the broader scope set forth in the appended claims. The specification and drawings are, accordingly, to be regarded in an illustrative rather than a restrictive sense.

What is claimed is:

1. A flip-chip bonded photonic device, comprising:
a spot size converter; and
an antireflective coating on a sidewall of the spot size converter.

2. The flip-chip bonded photonic device of claim 1, the antireflective coating comprising two dielectric layers of silicon dioxide.

3. The flip-chip bonded photonic device of claim 1, the spot size converter comprising silicon nitride.

4. The flip-chip bonded photonic device of claim 1, the spot size converter fabricated without planarization.

5. A flip-chip bonded photonic device, comprising:
a semiconductor layer comprising a stack of quantum wells; and
an etch stop semiconductor layer beneath the layer comprising a stack of quantum wells.

6. The flip-chip bonded photonic device of claim 5, the etch stop layer being heavily N-doped.

7. The flip-chip bonded photonic device of claim 5, the semiconductor layer comprising a stack of quantum wells comprising a laser.

8. The flip-chip bonded photonic device of claim 5, the semiconductor layer comprising a stack of quantum wells comprising an electro-absorption modulator.

9. A flip-chip bonded semiconductor device, comprising:
a vertical sidewall for optical coupling; and
a sloped sidewall for metal interconnects.

10. The flip-chip bonded semiconductor device of claim 9, the metal interconnects being high speed interconnects.

11. The flip-chip bonded semiconductor device of claim 9, the metal interconnects having a large surface area to enhance thermal conduction.

12. The flip-chip bonded semiconductor device of claim 10, the flip-chip bonded semiconductor device comprising an electro-absorption modulator.

13. The flip-chip bonded semiconductor device of claim 12, further comprising:
an integrated termination resistor; and
an integrated decoupling capacitor.

14. The flip-chip bonded semiconductor device of claim 11, the flip-bonded semiconductor device comprising a continuous wave distributed feedback laser.

15. The flip-chip bonded semiconductor device of claim 11, the metal interconnects each having a length in the range of 10 microns to 10 millimeters.

16. A flip-chip bonded photonic device comprising:
a substrate;
an optical waveguide residing above substrate;
a mirror coupled to the optical waveguide that bends light from the optical waveguide and transmits the light through the substrate, the light expanding as it passes through the substrate; and
a collimating lens fabricated on the back side of the substrate for receiving the light transmitted through the substrate and lithographically aligned with the mirror.

17. The flip-chip bonded photonic device of claim 16, further comprising a buried oxide layer residing beneath the optical waveguide.

18. The flip-chip bonded photonic device of claim 16, the mirror bending the light by 90 degrees.

19. The flip-chip bonded photonic device of claim 16, the collimating lens sending parallel beams of light to a lens of a fiber array.

20. The flip-chip bonded photonic device of claim 16, the flip-chip bonded photonic device comprising an electro-absorption modulated laser (EML).

21. The flip-chip bonded photonic device of claim 16, the flip-chip bonded photonic device comprising an electro-absorption modulator (EAM).

22. An optical bridge comprising:
a substrate;
an optical waveguide residing above the substrate;
a first mirror coupled to a first end of the optical waveguide that bends light from the optical waveguide and transmits the light through the substrate, the light expanding as it passes through the substrate;
a second mirror coupled to a second end of the optical waveguide that bends light from the optical waveguide and transmits the light through the substrate, the light expanding as it passes through the substrate;
a first collimating lens fabricated on the back side of the substrate for receiving the light transmitted through the substrate and lithographically aligned with the first mirror; and
a second collimating lens fabricated on the back side of the substrate for receiving the light transmitted through the substrate and lithographically aligned with the second mirror.

23. The optical bridge of claim 22, further comprising a buried oxide layer residing beneath the optical waveguide.

24. The optical bridge of claim 22, the first and second mirrors each bending the light by 90 degrees.

25. The optical bridge of claim 22, the first collimating lens sending parallel beams of light to a lens of a first optical engine and the second collimating lens sending parallel beams of light to a lens of a second optical engine.

26. The optical bridge of claim 22, wherein the optical bridge, the first optical engine, and the second optical engine are part of an optical quantum computer.

27. A method of fabricating a flip-chip bonded photonic device, comprising:
depositing a first dielectric layer acting as an etch-stop layer on a silicon-on-insulator (SOI) substrate;
patterning a waveguide above the dielectric etch stop layer;
after the waveguide is patterned, depositing a spot size converter and patterning so that a first end portion of the spot size converter resides over a portion of the waveguide;
depositing cladding over the waveguide and the spot size converter;
depositing a second dielectric layer that covers a side of the spot size converter opposite the waveguide; and
depositing a third dielectric layer over the second dielectric layer that covers the side of the spot size converter opposite the waveguide.

28. The method of claim 27 of fabricating a flip-chip bonded photonic device, wherein the spot size converter comprises silicon nitride.

29. The method of claim 27 of fabricating a flip-chip bonded photonic device, the first and second dielectric layers each comprising silicon dioxide.

30. The method of claim 27 of fabricating a flip-chip bonded photonic device, the dielectric etch-stop layer deposited on the silicon-on-insulator (SOI) substrate comprising aluminum oxide.

31. The method of claim 27 of fabricating a flip-chip bonded photonic device, further comprising depositing a fourth dielectric layer over the waveguide to protect the waveguide prior to the patterning of the spot size converter.

32. A method of forming a flip-chip bonded photonic device, comprising:
forming an etch stop semiconductor layer in a substrate; and
forming a semiconductor layer comprising a stack of quantum wells above the etch stop semiconductor layer.

33. The method of claim 32 of forming a flip-chip bonded photonic device, the etch stop semiconductor layer being formed by doping the substrate.

34. The method of claim 32 of forming a flip-chip bonded photonic device, the etch stop layer being formed by heavily N-doping the substrate.

35. A method of forming a flip-chip bonded semiconductor device, comprising:
etching with a first mask to form a vertical sidewall for optical coupling; and
etching with a second mask to form a sloped sidewall for metal interconnects.

36. A method of forming a flip-chip bonded photonic device, comprising:
depositing a silicon dioxide layer on a silicon on insulator (SOI) layer on a substrate;
growing a silicon epitaxial layer over the silicon dioxide layer in a window in a dielectric layer over the silicon dioxide layer;
forming a 45-degree mirror in the silicon epitaxial layer;
flipping the substrate;
patterning photoresist lithographically aligned to the mirror and reflowing the photoresist to form a spherical shape as an etch mask; and
etching to form a lens.

37. The method of claim 36 of forming a flip-chip bonded photonic device, the lens being a collimating lens.

38. The method of claim 36 of forming a flip-chip bonded photonic device, further comprising depositing an absorber around the lens.

39. The method of claim 36 of forming a flip-chip bonded photonic device, the 45-degree mirror being formed with a crystal wet etch.

40. The method of claim 36 of forming a flip-chip bonded photonic device, the 45-degree mirror being formed with ion milling.

41. The method of claim 36 of forming a flip-chip bonded photonic device, the 45-degree mirror being formed with dry etching.

42. An optical engine comprising:
a flip-chip integrated electro-absorption modulated laser (EML) on a substrate comprising:
a continuous wave distributed feedback laser; and
an electro-absorption modulator (EAM);
a laser monitor on the substrate; and
a photodetector on the substrate.

43. The optical engine of claim 42, further comprising a wavelength division multiplexer on the substrate.

44. The optical engine of claim 42, the EML being comprised of Indium Phosphide (InP).

45. The optical engine of claim 42, the laser monitor and the photodetector each being comprised of Germanium (Ge).

46. An optical engine comprising:
a flip-chip integrated electro-absorption modulator (EAM) on a substrate;
a laser that is separate from the EAM; and
a photodetector on the substrate.

47. The optical engine of claim 46, the laser being a flip-chip laser separately integrated on the substrate.

48. The optical engine of claim 47, further comprising a laser monitor on the substrate.

49. The optical engine of claim 46, the laser residing external to the substrate.

50. The optical engine of claim 46, further comprising a wavelength division multiplexer on the substrate.

51. The optical engine of claim 46, further comprising a coupler.
